(19) United States
(12) Patent Application Publication
(10) Pub. No.: US 2003/0032737 A1
(43) Pub. Date: Feb. 13, 2003

(54) Polyester compositions of low residual aldehyde content

(76) Inventors: Stephen Andrews, New Fairfield, CT (US); Dario Lazzari, Bologna (IT); Dirk Simon, Mutterstadt (DE)

Correspondence Address: CIBA SPECIALTY CHEMICALS CORPORATION, PATENT DEPARTMENT, 540 WHITE PLAINS RD, P O BOX 2005, TARRYTOWN, NY, 10591-9005, US

(21) Appl. No.: 10/209,353

(22) Filed: Jul. 31, 2002

Related U.S. Application Data
(63) Continuation of application No. 09/603,506, filed on Jun. 26, 2000.
(60) Provisional application No. 60/141,664, filed on Jun. 30, 1999.

(51) Int. Cl. C08F 20/00

(52) U.S. Cl. 525/437

(57) ABSTRACT

A mixture of a polyester, such as poly(ethylene terephthalate) PET, and a suitable polyhydric alcohol when extrusion compounded exhibits a lower residual acetaldehyde content than does PET alone when similarly treated. The invention pertains to any polyester used in the manufacture of bottles or containers which in turn are used to store consumer materials, especially food, beverages and most especially water.

This application claims benefit under 35 USC 119(e) of U.S. Provisional Application No. 60/141,664, filed on Jun. 30, 1999.

A mixture of a polyester, such as poly(ethylene terephthalate) PET, and a suitable polyhydric alcohol when extrusion compounded exhibits a lower residual acetaldehyde content than does PET alone when similarly treated. The invention pertains to any polyester used in the manufacture of bottles or containers which in turn are used to store consumer materials, especially food, beverages and most especially water.

### BACKGROUND OF THE INVENTION

U.S. Pat. No. 4,361,681 teaches that polyester containing anhydride end-cap agents have a reduced acetaldehyde generation rate.

U.S. Pat. No. 5,459,224 discloses polyesters having 4-oxybenzylidene end-cap agents to impart improved weatherability and photostability, but no mention is made as to evolution of acetaldehyde. However, it is indicated that such polyesters are suitable for food and beverage packaging.

Polyesters can be synthesized by a number of routes known in the art using a variety of catalyst systems. EP 826,713 A1 teaches that lower levels of acetaldehyde occur during copolymerization of PET when a phosphite such as bis(2,4-di-tert-butylphenyl)-pentaerythritol phosphite is present during the polymerization.

U.S. Pat. Nos. 4,837,115; 5,258,233; 5,266,413; 5,340,884; 5,648,032 and 5,650,469; and WO 93/20147 A1; WO 93/23474 A1; WO 98/07786 and WO 98/39388 teach the use of polyamides as a means of reducing the concentration of acetaldehyde, presumedly via a Schiff-base reaction with the aldehyde, which is reversible in the presence of water.

EP application 191,701A2 describes biaxially oriented container having excellent barrier properties said container comprising a blend of a poly(ethylene terephthalate) resin and an ethylene-vinyl alcohol copolymer resin. This reference is focused on improved gas barrier properties and is silent as to any reduction of acetaldehyde content.

Japanese Sho 62-257959 describes biaxially stretched vessels built of synthetic resin consisting of poly(ethylene terephthalate) blended with a copolymer of a polyamide, or blended with ethylene-vinyl alcohol at a weight fraction of 0.1 to 15 percent. The examples are limited to a single EVOH polymer (EVEL® G110, Kuraray Co.). It is taught that a lower level of acetaldehyde occurs when the EVOH polymer is present.

European application 714,832A1 teaches a method of manufacturing a container comprising poly(ethylene terephthalate), polycarbonate or PEN polyester with an additive in the bottle wall which binds acetaldehyde. The additives is generally described as a polyamide.

U.S. Pat. No. 5,656,221 describes a process of producing polyester with reduced acetaldehyde concentration using certain catalysts or inert gas conditions or by adding an amide compound. These include commercial polyamides or long chain aliphatic amide compounds.

U.S. Pat. No. 5,856,385 teaches the use of polyamide or amide-wax to reduce the level of acetaldehyde which occurs when sorbitol-based clarifying agent is heated in polyolefins.

The instant invention is useful for any polyester where aldehydic compounds, especially acetaldehyde, are formed or evolved during thermal processing of said polyester. Thermal processing of PET includes the synthesis of PET, thermal exposure during solid state polymerization (SSP), any injection molding, injection-blow molding or stretch-blow molding used in the manufacture of preforms, parissons, or bottles and containers, or extrusion of film, or during any melt processing of PET above its glass transition temperature and below its decomposition temperature.

The instant invention provides for a lower amount of contaminants (e.g. aldehydes) in PET water bottles thus providing for improved taste or flavor in bottled water or other bottled beverages in said PET containers. The reduction in the amount of acetaldehyde is highly beneficial in this respect. Acetaldehyde is known as a decomposition product of polyesters such as PET. The acetaldehyde imparts an undesirable taste or flavor to bottled water stored in PET bottles. It has been a long sought objective of the industry to reduce the level of acetaldehyde which migrates out of the PET bottle walls into the water or other beverage stored therein. A number of engineering or design changes to extruders, injection molding machines for preforms and bottle making machinery have been made to minimize formation of acetaldehyde when poly (ethylene terephthalate) PET is processed. Modification to the PET composition itself have been made to lower its melting point or its melt viscosity in order to allow less severe thermal or mechanical damage when PET is processed into preforms or bottles.

### DETAILED DISCLOSURE

The instant invention pertains to a polyester composition, stabilized against the formation of aldehydic contaminants during melt processing of said polyester, which comprises

(a) a polyester, and

(b) an effective stabilizing amount of a polyhydric alcohol of the formula

E-(OH)ₙ

where

n is 2 to 4000, and

E is an aliphatic, cycloaliphatic, aromatic or a mono-, di- or poly-saccharride moiety.

The polyester of component (a) is 95-99.99% by weight of the stabilized composition; and the polyhydric alcohol of component (b) is 5 to 0.01% by weight of the stabilized composition.

Preferably, component (a) is 98-99.99% by weight and component (b) is 2 to 0.01% by weight of the stabilized composition; most preferably component (a) is 99 to 99.97% by weight and component (b) is 1 to 0.03% by weight of the stabilized composition.

The polyester of component (a) has dicarboxylic acid repeat units selected from the group consisting of aromatic dicarboxylic acids having 8 to 14 carbon atoms, aliphatic dicarboxylic acids having 4 to 12 carbon atoms, cycloaliphatic dicarboxylic acids having 8 to 12 carbon atoms, and mixtures thereof.

Preferably such diacids are terephthalic acid, isophthalic acid, o-phthalic acid, naphthalene dicarboxylic acid, cyclohexane dicarboxylic acid, cyclohexanediacetic acid, diphenyl-4,4′-dicarboxylic acid, succinic acid, glutaric acid, adipic acid, sebacic acid and mixtures thereof.

Especially preferred are terephthalic acid and 2,6-naphthalene dicarboxylic acid.

The diol or glycol portion of the polyester of component (a) are derived from the generic formula HO—R—OH where R is an aliphatic, cycloaliphatic or aromatic moiety of 2 to 18 carbon atoms.

Preferably such diols or glycols are ethylene glycol, diethylene glycol, triethylene glycol, propane-1,3-diol, butane-1,4-diol, pentane-1,5-diol, hexane-1,6-diol, 1,4-cyclohexanedimethanol, 3-methylpentane-2,4-diol, 2-methylpentane 1,4-diol, 2,2-diethylpropane-1,3-diol, 1,4-di-(hydroxyethoxy)benzene, 2,2-bis(4-hydroxycyclohexyl)-propane, 2,4-dihydroxy-1,1,3,3-tetramethylcyclobutane, 2,2-bis-(3-hydroxyethoxyphenyl)propane, 2,2-bis-(4-hydroxypropoxyphenyl)ethane and mixtures thereof.

Most preferably, the diol is ethylene glycol.

The polyester of component (a) is preferably poly(ethylene terephthalate) PET or poly(ethylene 2,6-naphthalene-2,6-dicarboxylate); most preferably poly(ethylene terephthalate).

It is also contemplated that the polyester of component (a) can also be a blend of polyesters or copolyesters including components mentioned above.

It is contemplated that the polyester of component (a) can be virgin polymer or alternatively polymer recyclate. Additionally, it is possible to add the polyhydric alcohol described for component (b) as part of a concentrate with a polyester carrier resin.

Component (b) is a polyhydric alcohol, preferably starch, cellulose or a sugar or a sugar alcohol.

Most preferably, the polyhydric alcohol is cellulose or starch.

Other preferred polyhydric alcohols include degraded starch (dextrins and cyclodextrins), maltose and its derivatives, maltitol, maltopentaose hydrate, maltoheptaose, maltotetraose, maltulose monohydrate, D,L-glucose, dextrose, sucrose and D-mannitol.

Other commercial polyhydric alcohols include trimethylol propane, triethylol propane, glycerol, sorbitol and pentaerythritol.

The instant invention also pertains to a process for preventing the formation of aldehydic contaminants during melt processing of a polyester which comprises

incorporating into said polyester an effective stabilizing amount of a polyhydric alcohol.

The following examples are for illustrative purposes only and are not to be construed to limit the scope of the instant invention in any manner whatsoever.

General—PET bottle grade pellets are subjected to extrusion compounding to simulate the heat history which PET experiences when thermally injection molded into bottle preforms and subsequently stretch-blow molded into bottles. The efficacy of an additive added to reduce the formation of acetaldehyde is determined by quantitative analysis using thermal desorption GC-MS after adaption of published methods. An unstabilized PET is extruded each day to provide a control polymer for measuring acetaldehyde formation.

Extrusion—PET is predried in vacuo under nitrogen at an oven temperature of about 70° C. to a moisture level of about 30 ppm which is verified on a Mitsubishi VA-O6 moisturemeter. A Leistritz 18 mm or 27 mm corotating, non-intermeshing twin screw extruder is configured as follows: set temps=throat (220-230° C.), zones and die (270° C.), actual extrudate melt temperature is 275-280° C., screw at 100-110 rpm, hopper feeder=10-15 ppm.

PET Pellet Color—Yellowness Index (YI), and L*, a*, b* by ASTM D1925, D65 10 degm specular included, measured on PET pellets using a DCI spectrophotometer.

Acetaldehyde Analysis—The concentration of acetaldehyde in PET is quantitatively determined using a thermal desorption GC-MS method adapted from B. Nijassen et al., Packaging Technology and Science, 9, 175 (1996); S. Yong Lee, SPE ANTEC 1997, pp 857-861; and M. Dong et al., J. Chromatographic Science, 18, 242 (1980). A general example follows below:

The PET samples are analyzed, in duplicate, by weighing 250 mg of powdered PET pellets (cryogenically pulverized) in a 5 mL crimp sealed headspace vial. The sample vial is heated at 120° C. for one hour in a Tekmar model 5000 static headspace analyzer. The headspace gas (5 cc) is then transferred via a heated transfer line to a Fisons MD-800 GC-MS system for SIR detection of the acetaldehyde. The acetaldehyde is detected by monitoring its fragment ions of 29 and 44 m/e. The Total Ion Current (TIC) of the GC-MS is also monitored in the retention time region of 4-8 minutes. By doing this the presence of acetaldehyde in the samples is confirmed by three different detectors. By using a known acetaldehyde value for PET, the ration of peak areas for the known PET resin and for the experimental PET resin blends are compared and the amount of acetaldehyde in the experimental blend can be obtained.

### EXAMPLE 1

Unstabilized commercial PET (CLEARTUF® 7207, Shell) is used as a control PET. Several additives listed below demonstrate a significant reduction in the amount of acetaldehyde (AA) versus the amount seen when unstabilized PET is extrusion compounded. The % AA reduction is the amount less compared to the amount of AA in the control. The total ion current (TIC) data run in triplicate for the control PET has a standard deviation of σ=0.35.

| | Additive | % AA | TIC |
|---|---|---|---|
| Sample* | ppm | Reduction | ave ppm AA |
| Control | none | — | 6.8 |
| A | 400 | 19 | 5.5 |
| A | 1600 | 16 | 5.7 |
| A | 4000 | 22 | 5.3 |
| B | 400 | 26 | 5.0 |
| B | 1600 | 29 | 4.8 |
| B | 4000 | 28 | 4.9 |

*A is celluose.
B is starch.

The use of the polyhydric alcohol results in the reduction of acetaldehyde versus the control.

### EXAMPLE 2

In another series of tests following the general procedure of Example 1, starch is seen to be generally effective in reducing the level of acetaldehyde in PET after one extrusion compounding operation.

| | Additive | % AA | TIC |
|---|---|---|---|
| Sample* | wgt % | Reduction | ave ppm AA |
| Control | none | — | 4.6 |
| B | 0.16 | 24 | 3.5 |
| B | 1.00 | 30 | 3.2 |

*B is starch.

What is claimed is:

1. A polyester composition, stabilized against the formation of aldehydic contaminants during melt processing of said polyester, which comprises
(a) a polyester, and
(b) an effective stabilizing amount of a polyhydric alcohol of the formula
E-(OH)ₙ
where
n is 2 to 4000, and
E is an aliphatic, cycloaliphatic, aromatic or a mono-, di- or poly-saccharride moiety.

2. A composition according to claim 1 wherein the polyester of component (a) is 95-99.99% by weight of the stabilized composition; and the polyhydric alcohol of component (b) is 5 to 0.01% by weight of the stabilized composition.

3. A composition according to claim 2 wherein component (a) is 99-99.99% by weight of the stabilized composition; and component (b) is 2 to 0.01% by weight of the stabilized composition.

4. A composition according to claim 3 wherein component (a) is 99-99.97% by weight of the stabilized composition; and component (b) is 1 to 0.03% by weight of the stabilized composition.

5. A composition according to claim 1 wherein the polyester of component (a) has dicarboxylic acid repeat units selected from the group consisting of aromatic dicarboxylic acids having 8 to 14 carbon atoms, aliphatic dicarboxylic acids having 4 to 12 carbon atoms, cycloaliphatic dicarboxylic acids having 8 to 12 carbon atoms, and mixtures thereof.

6. A composition according to claim 5 wherein the dicarboxylic acid is terephthalic acid, isophthalic acid, o-phthalic acid, naphthalene dicarboxylic acid, cyclohexane dicarboxylic acid, cyclohexanediacetic acid, diphenyl-4,4′-dicarboxylic acid, succinic acid, glutaric acid, adipic acid, sebacic acid and mixtures thereof.

7. A composition according to claim 6 wherein the dicarboxylic acid is terephthalic acid or 2,6-naphthalene dicarboxylic acid.

8. A composition according to claim 1 wherein the diol portion of the polyester of component (a) is derived from the generic formula HO—R—OH where R is an aliphatic, cycloaliphatic or aromatic moiety of 2 to 18 carbon atoms.

9. A composition according to claim 8 wherein the diol is ethylene glycol, diethylene glycol, triethylene glycol, propane-1,3-diol, butane-1,4-diol, pentane-1,5-diol, hexane-1,6-diol, 1,4-cyclohexanedimethanol, 3-methylpentane-2,4-diol, 2-methylpentane-1,4-diol, 2,2-diethylpropane-1,3-diol, 1,4-di-(hydroxyethoxy)benzene, 2,2-bis(4-hydroxycyclohexyl)-propane, 2,4-dihydroxy-1,1,3,3-tetramethylcyclobutane, 2,2-bis-(3-hydroxyethoxyphenyl)propane, 2,2-bis-(4-hydroxypropoxyphenyl)ethane and mixtures thereof.

10. A composition according to claim 9 wherein the diol is ethylene glycol.

11. A composition according to claim 1 wherein the polyester of component (a) is poly(ethylene terephthalate) PET or poly(ethylene 2,6-naphthalene-2,6-dicarboxylate).

12. A composition according to claim 11 wherein the polyester is poly(ethylene terephthalate).

13. A composition according to claim 1 wherein the polyhydric alcohol of component (b) is starch, cellulose or a sugar or a sugar alcohol.

14. A composition according to claim 13 wherein the polyhydric alcohol is cellulose or starch.

15. A composition according to claim 1 wherein the polyhydric alcohol is selected from the group consisting of degraded starch (dextrins and cyclodextrins), maltose and its derivatives, maltitol, maltopentaose hydrate, maltoheptaose, maltotetraose, maltulose monohydrate, D,L-glucose, dextrose, sucrose and D-mannitol.

16. A composition according to claim 1 wherein the polyhydric alcohol is selected from the group consisting of trimethylol propane, triethylol propane, glycerol, sorbitol and pentaerythritol.

17. A process for preventing the formation of aldehydic contaminants during melt processing of a polyester which comprises
incorporating into said polyester an effective stabilizing amount of a polyhydric alcohol.
